(19) United States
(12) Patent Application Publication
(10) Pub. No.: US 2026/0034531 A1
(43) Pub. Date: Feb. 5, 2026

(54) MULTIFUNCTIONAL HIERARCHICAL POROUS CARBON AEROGELS

(71) Applicant: The Trustees of Princeton University, Princeton, NJ (US)

(72) Inventors: Craig B. ARNOLD, Skillman, NJ (US); Sehmus OZDEN, Princeton, NJ (US); Rodney D. PRIESTLEY, Princeton, NJ (US); M. Shaharyar WANI, Princeton, NJ (US)

(73) Assignee: The Trustees of Princeton University, Princeton, NJ (US)

(21) Appl. No.: 19/099,870

(22) PCT Filed: Aug. 2, 2023
(86) PCT No.: PCT/US2023/029266

§ 371 Date: Jan. 30, 2025

Related U.S. Application Data
(60) Provisional application No. 63/394,333, filed on Aug. 2, 2022.

(51) Int. Cl. B01J 20/20; B01J 20/28; C01B 32/05; C02F 1/28; C02F 101/32; C02F 103/08

(52) U.S. Cl. CPC B01J 20/20; B01J 20/28011; B01J 20/28045; C01B 32/05; C02F 1/283; C02F 2101/32; C02F 2103/08

(57) ABSTRACT

A novel method for forming unique carbon aerogels may be provided. The method may include drying a precursor composition including an organic molecule. The method may include generating a porous aerogel by graphitizing the organic molecule (such as a self-assembling protein, a sugar, etc.). The organic molecule may be a phase transition material, where the heating leads to formation of a viscous melt pool, and further heating of which releases gases such as CO₂, NH₃, H₂S, SO₂, etc. Due to the use of such a phase transition material, generating the porous aerogel may be accomplished without a separate gas generant. The graphitizing may include heating the precursor composition to a first temperature of 300-1200° C. at a first heating rate. The graphitizing may include holding the precursor composition at the first temperature for a holding time no more than 48 hours.

### CROSS-REFERENCE TO RELATED APPLICATIONS

The present application claims priority to U.S. Provisional Patent Application No. 63/394,333, filed Aug. 2, 2022, the contents of which are incorporated by reference herein in its entirety.

### STATEMENT REGARDING FEDERALLY SPONSORED RESEARCH OR DEVELOPMENT

This invention was made with government support under grants DMR1420541 and DMR2011750 awarded by the National Science Foundation. The government has certain rights in the invention.

### TECHNICAL FIELD

The present disclosure is drawn to aerogels, ultra low-density carbon aerogels in particular, and techniques for forming such aerogels.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

The ability to create multifunctional hierarchical complex nanostructures are a topic of intrigue. Conventionally, such structures are usually fabricated using templating methods due to experimental limitations, and the resulting structures are relatively dense (such as 1 g/cm³ or more). To date, it has not been possible to create such very low density, functional aerogels.

### BRIEF SUMMARY

Various deficiencies in the prior art are addressed below by the disclosed compositions of matter and techniques.

In various aspects, a method for manufacturing a carbon aerogel may be provided. The method may include drying a precursor composition including an organic molecule. The method may include generating a porous aerogel by graphitizing the organic molecule. The graphitizing may include heating the precursor composition to a first temperature of 300-1200° C. at a first heating rate. The graphitizing may include holding the precursor composition at the first temperature for a holding time no more than 48 hours. Generating the porous aerogel may be accomplished without a separate gas generant.

The organic molecule may include a protein-based precursor and/or a sugar-based precursor. The protein-based precursor may include ovalbumin, whey protein, Bovine serum albumin, collagen gelatin, or a combination thereof.

The first temperature may be 300-1000° C. The heating rate may be at least 100° C./min. The heating rate may be no more than 100° C./min. The heating rate may be no more than 40° C./min. The heating rate may be 1-10° C./min. The heating rate may be 3-10° C./min.

The precursor composition may consist of the organic molecule. The precursor composition may consist of the organic molecule and one or more particles. The precursor composition may consist of the organic molecule and one or more metal particle precursors.

The particles or metal particle precursors may be present in a total concentration of no more than 20 mg/mL of the organic molecule. The particles or metal particle precursors may include a metal or a metalloid. The particles or metal particle precursors may include a metal or a non-metal.

In various aspects, a carbon aerogel may be provided, formed by the method as disclosed herein.

In various aspects, a carbon aerogel may be provided. The carbon aerogel may include micro-sized large graphitic carbon sheets interconnected with carbon fibers via covalent bonding. The carbon aerogel may include a plurality of micro-sized pores, and a plurality of nano-sized pores. The carbon aerogel may have a density of no more than 0.1 g/cm³. The carbon fibers may have an average fiber width of 46 μm or less. The carbon aerogel may have a carbon content of at least 60% by weight of the aerogel. The graphitic carbon sheets may contain a plurality of structural defects. The structural defects may include single-point defects, vacancy defects, or a combination thereof. Each of the plurality of structural defects may be a charged defect. The carbon aerogel may have a surface area of 735 m²/g or less. The carbon fiber may include interconnected dangling bonds of (i) 6-membered carbon rings and (ii) 5-membered carbon rings, 7-membered carbon rings, 8-membered carbon rings, or a combination thereof. One or more O-residual groups, N-residual groups, or both may be associated with the plurality of nano-sized pores, the plurality of structural defects, or both.

The carbon aerogel may include N, P, K, O, S, Mg, Cl, and/or Na.

The carbon aerogel may include at least one particle. In some embodiments, the at least one particle may be attached to the carbon aerogel. The at least one particle may be present in a concentration of no more than 1.1 mg per mg of carbon aerogel. The at least one particle may include a metal or a metalloid. The at least one particle may include a non-metal. A precursor of the carbon aerogel may include a self-assembling protein, such as an albumin. The albumin may be derived from cattle blood, human blood, or chicken eggs.

In various aspects, a filtration system may be provided. The filtration system may include a housing having an input and output. The filtration system may include a carbon aerogel as disclosed herein within the housing, disposed in a fluid path between the input and output.

In various aspects, a method for separating materials may be provided. The method may include passing a fluid containing a liquid and at least one additional material through a carbon aerogel as disclosed herein. The carbon aerogel may include one or more O-residual groups, N-residual groups, or both, associated with a plurality of nano-sized pores of the carbon aerogel, a plurality of structural defects of the carbon aerogel, or both. The liquid may be a polar liquid. The at least one additional material may include a salt or at least one microplastic. The method may include passing the fluid through a plurality of carbon aerogels. The at least one additional material may be captured on a surface of the nano-sized pores and/or structural defects. The method may include capturing at least some liquid after the fluid passes through the carbon aerogel. The method may include quantifying a first amount of one or more of the at least one additional material remaining in the captured liquid. The method may include comparing the first amount to a previously quantified amount.

### BRIEF DESCRIPTION OF DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 is an SEM image of the porous inner structure of the carbon aerogel, showing carbon sheets interconnected with carbon fibers.

FIG. 2 is an illustration of an aerogel within a housing.

FIG. 3 is an illustration representative of an HRTEM of interconnected graphitic carbon and carbon fiber.

FIG. 4 is a graph showing a comparison for salt adsorption capacity of G-CF aerogels with some reported carbon-based materials.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for illustrative purposes to aid the reader in understanding the principles of the invention and the concepts contributed by the inventor(s) to furthering the art and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others. Those skilled in the art and informed by the teachings herein will realize that the invention is also applicable to various other technical areas or embodiments.

In various aspects, a method for manufacturing a carbon aerogel may be provided.

The method may include drying a precursor composition including an organic molecule. Drying may include freeze drying, spray drying, filtering, or other known techniques for reducing the water content of the precursor composition including the organic molecule.

The organic molecule may be a phase transition material, where heating leads to formation of a viscous melt pool, and further heating releases gases such as CO₂, NH₃, H₂S, SO₂, etc. The organic molecule may include a protein-based precursor. The organic molecule may include a sugar-based precursor. The organic molecule may include both a protein-based precursor and a sugar-based precursor.

The protein-based precursor may include ovalbumin, whey protein, Bovine serum albumin, collagen gelatin, or a combination thereof. The protein-based precursor may include an albumin. The albumin may be derived from cattle blood, human blood, or chicken eggs.

The sugar-based precursor may be a sugar or a sugar derivative. The term “sugar derivative” includes derivatives of a monosaccharide sugar, i.e., a monosaccharide sugar comprising substituents and/or functional groups. Examples of a sugar derivative include amino sugars and sugar acids, e.g., glucosamine (GlcNH₂), galactosamine (GalNH₂)N-acetylglucosamine (GlcNAc), N-acetylgalactosamine (GalNAc), sialic acid (Sia) which is also referred to as N-acetylneuraminic acid (NeuNAc), and N-acetylmuramic acid (MurNAc), glucuronic acid (GlcA) and iduronic acid (IdoA). The sugar-based precursor may include glucose or a derivative thereof.

In some embodiments, the precursor composition may include the organic molecule and may be substantially free of any other material. As used herein, the term “substantially free [of a material]” refers to having less than 1% by weight of the material in the composition. In some embodiments, the precursor composition may consist of the organic molecule. In some embodiments, the precursor composition may include the organic molecule and at least one other material. The at least one other material may include, e.g., a particle and/or a metal particle precursor. As used here, “metal particle precursors” refers to materials, such as metal oxides, that reduce to form metal particles when heated under appropriate conditions. In some embodiments, the precursor composition may include the organic molecule and one or more particles, and may be substantially free of any other material. In some embodiments, the precursor composition may consist of the organic molecule and one or more particles. In some embodiments, the precursor composition may include of the organic molecule and one or more metal particle precursors, and may be substantially free of any other material. In some embodiments, the precursor composition may consist of the organic molecule and one or more metal particle precursors.

The particles and/or metal particle precursors may include a metal or a metalloid. The particles and/or metal particle precursors may include a metal or a non-metal.

The particles and/or metal particle precursors may be present in a total concentration of no more than 20 mg/mL of the organic molecule. The particles and/or metal particle precursors may be present in a total concentration of no more than 15 mg/mL of the organic molecule. The particles and/or metal particle precursors may be present in a total concentration of no more than 10 mg/mL of the organic molecule. The particles and/or metal particle precursors may be present in a total concentration of no more than 9 mg/mL of the organic molecule. The particles and/or metal particle precursors may be present in a total concentration of no more than 8 mg/mL of the organic molecule. The particles and/or metal particle precursors may be present in a total concentration of no more than 7 mg/mL of the organic molecule. The particles and/or metal particle precursors may be present in a total concentration of no more than 6 mg/mL of the organic molecule. The particles and/or metal particle precursors may be present in a total concentration of no more than 5 mg/mL of the organic molecule. The particles and/or metal particle precursors may be present in a total concentration of no more than 4 mg/mL of the organic molecule. If the concentration is too high, the aerogel may not form.

The method may include generating a porous aerogel by graphitizing the organic molecule. As disclosed herein, the organic molecule may be a phase transition material that, when heated, forms a viscous melt pool, and upon further heating, releases gases. The porous aerogel may be formed by the foaming of the melt pool, facilitated by the gas evolution and reorganization of residual carbon-based compounds in the melt pool to form the structure. As will be recognized, due to the use of the phase transition material, generating the porous aerogel may be accomplished without a separate gas generant.

The graphitizing may include heating the precursor composition to a first temperature at a first heating rate. The heating may occur in an inert atmosphere. The inert atmosphere may include nitrogen, argon, or a combination thereof.

The first temperature may be 300-1400° C. The first temperature may be 300-1300° C. The first temperature may be 300-1200° C. The first temperature may be 300-1100° C. The first temperature may be 300-1000° C. The first temperature may be at least 300° C. The first temperature may be at least 400° C. The first temperature may be at least 500° C. The first temperature may be at least 600° C. The first temperature may be at least 700° C. The heating rate may be at least 800° C./min. The first temperature may be at no more than 1400° C. The first temperature may be at no more than 1300° C. The first temperature may be at no more than 1200° C. The first temperature may be at no more than 1100° C. The first temperature may be at no more than 1000° C.

The heating rate may be no more than 300° C./min. The heating rate may be no more than 200° C./min. The heating rate may be no more than 100° C./min. The heating rate may be no more than 40° C./min. The heating rate may be no more than 10° C./min. The heating rate may at least 1° C./min. The heating rate may at least 3° C./min. The heating rate may at least 10° C./min. The heating rate may at least 40° C./min. The heating rate may at least 100° C./min. The heating rate may at least 150° C./min. In some embodiments, the heating rate may be 1-10° C./min. In some embodiments, the heating rate may be 3-10° C./min.

The graphitizing may include holding the precursor composition at the first temperature for a holding time. The holding time may be no more than 48 hours. The holding time may be no more than 36 hours. The holding time may be no more than 24 hours. The holding time may be no more than 12 hours. The holding time may be no more than 6 hours. The holding time may be no more than 1 hour. The holding time may be at least 1 minute. The holding time may be at least 1 hour. The holding time may be at least 2 hours. The holding time may be at least 3 hours. The holding time may be at least 6 hours. The holding time may be at least 12 hours.

The graphitizing is preferably done in an inert atmosphere. In some embodiment, the heating and holding is done in a nitrogen atmosphere.

The formed carbon aerogel may include graphitic carbon. The carbon aerogel may include turbostratic carbon. The carbon aerogel may include amorphous carbon.

The carbon aerogel may have a carbon content of at least 60% by weight of the aerogel. The carbon aerogel may have a carbon content of at least 65% by weight of the aerogel. The carbon aerogel may have a carbon content of at least 70% by weight of the aerogel. The carbon aerogel may have a carbon content of at least 75% by weight of the aerogel. The carbon aerogel may have a carbon content of at least 80% by weight of the aerogel. The carbon aerogel may have a carbon content of at least 85% by weight of the aerogel. The carbon aerogel may have a carbon content of at least 90% by weight of the aerogel. The carbon aerogel may have a carbon content of less than 100% by weight of the aerogel. The carbon aerogel may have a carbon content of less than 98% by weight of the aerogel. The carbon aerogel may have a carbon content of no more than 95% by weight of the aerogel. The carbon aerogel may have a carbon content of no more than 90.5% by weight of the aerogel.

Typically, impurities in the carbon aerogel will arise from the precursor. As such, starting with synthetic precursor, one would expect lower impurities and more carbon in the final product than from a “natural” precursor. The term “impurities” as used herein refers to any material not desired to be included in the aerogel. In some embodiments, this may include inorganics, such as metals. As will be understood, with an organic molecule as a precursor, materials besides carbon may exist in the precursor (such as H, N, and O), and depending on the selected heating process, some non-carbon material may remain of the precursor, thus resulting in an aerogel of less than 100% carbon.

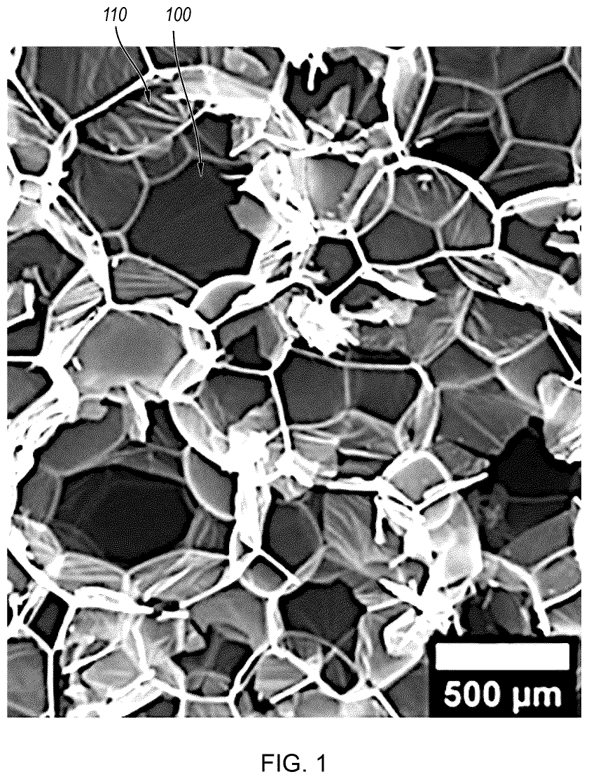

Referring to FIG. 1, the carbon aerogel may include micro-sized large graphitic carbon sheets 100 interconnected with carbon fibers 110 via covalent bonding. Each carbon fiber may have a maximum fiber width of 150 μm or less. Each carbon fiber may have a maximum fiber width of 125 μm or less. Each carbon fiber may have a maximum fiber width of 100 μm or less. Each carbon fiber may have an average fiber width of 100 μm or less. Each carbon fiber may have an average fiber width of 75 μm or less. Each carbon fiber may have an average fiber width of 50 μm or less. Each carbon fiber may have an average fiber width of 46 μm or less. In some embodiments, the carbon fibers, combined, may have an average fiber width of 100 μm or less. In some embodiments, the carbon fibers, combined, may have an average fiber width of 75 μm or less. In some embodiments, the carbon fibers, combined, may have an average fiber width of 50 μm or less. In some embodiments, the carbon fibers, combined, may have an average fiber width of 46 μm or less.

The carbon aerogel may include a plurality of micro-sized pores (e.g., an average effective diameter D of 1 μm≤D<1 mm), and a plurality of nano-sized pores (e.g., an average effective diameter D of 1 nm≤D<1 μm).

The carbon aerogel has a very low density. The carbon aerogel may have a density of no more than 0.1 g/cm³. The carbon aerogel may have a density of no more than 0.075 g/cm³. The carbon aerogel may have a density of no more than 0.05 g/cm³. The carbon aerogel may have a density of no more than 0.05 g/cm³. The carbon aerogel may have a density of no more than 0.025 g/cm³. These densities are orders of magnitude less dense than conventional carbon aerogels.

The graphitic carbon sheets may contain a plurality of structural defects. As used herein, “structural defects” do not include pores. Instead, “structural defects” are intended to refer to atomic-scale defects, such as single-point defects, vacancy defects, or a combination thereof. Each of the plurality of structural defects may be a charged defect.

The carbon aerogel may have a surface area of 1000 m²/g or less. The carbon aerogel may have a surface area of 950 m²/g or less. The carbon aerogel may have a surface area of 900 m²/g or less. The carbon aerogel may have a surface area of 850 m²/g or less. The carbon aerogel may have a surface area of 800 m²/g or less. The carbon aerogel may have a surface area of 750 m²/g or less. The carbon aerogel may have a surface area of 735 m²/g or less. The carbon aerogel may have a surface area of 700 m²/g or less. The carbon aerogel may have a surface area of 600 m²/g or less. The carbon aerogel may have a surface area of 500 m²/g or less. The carbon aerogel may have a surface area of 400 m²/g or less. The carbon aerogel may have a surface area of 300 m²/g or less. The carbon aerogel may have a surface area of 200 m²/g or less. The carbon aerogel may have a surface area of 100 m²/g or less. The carbon aerogel may have a surface area of at least 30 m²/g. The carbon aerogel may have a surface area of at least 35 m²/g. The carbon aerogel may have a surface area of at least 40 m²/g. The carbon aerogel may have a surface area of at least 50 m²/g. The carbon aerogel may have a surface area of at least 100 m²/g. The carbon aerogel may have a surface area of at least 200 m²/g. The carbon aerogel may have a surface area of at least 300 m²/g. The carbon aerogel may have a surface area of at least 400 m²/g. The carbon aerogel may have a surface area of at least 500 m²/g. The carbon aerogel may have a surface area of at least 600 m²/g.

The carbon aerogel may include carbon and one or more additional materials. The one or more additional materials may include an alkali metal (e.g., Na, K, etc.). The one or more additional materials may include an alkaline earth metal (e.g., Mg, Ca, etc.). The one or more additional materials may include a reactive non-metal (e.g., N, P, O, S, F, Cl, etc.). The one or more additional materials may include N, P, K, O, S, Mg, Cl, and/or Na may be present in a total amount no more than 20% by weight of the aerogel. In some embodiments, the one or more additional materials may be present in a total amount no more than 15% by weight of the aerogel. In some embodiments, the one or more additional materials may be present in a total amount no more than 10% by weight of the aerogel. In some embodiments, the one or more additional materials may be present in a total amount no more than 5% by weight of the aerogel. In some embodiments, the one or more additional materials may be present in a total amount no more than 1% by weight of the aerogel.

In some embodiments, the carbon aerogel may consist of carbon, optionally hydrogen, optionally nitrogen, and one or more further components. The one or more further components may be present in a total amount less than 5% by weight of the aerogel. In some embodiments, the one or more further components may be present in a total amount less than 1% by weight of the aerogel.

At least one particle may be operably coupled to the aerogel. In some embodiments, the at least one particle may be covalently bound to the carbon aerogel. In some embodiments, the at least one particle may be distributed over the surface of the aerogel. In some embodiments, the at least one particle may be embedded in the aerogel. In some embodiments, particles may be distributed over the surface of the aerogel and embedded in the aerogel. In some embodiments, the particle may be a metal. In some embodiments, the particle may be a metalloid. In some embodiments, the particle may include a non-metal.

The at least one particle may be present in a total concentration of no more than 1.1 mg per mg of carbon aerogel. The at least one particle may be present in a total concentration of no more than 1.0 mg per mg of carbon aerogel. The at least one particle may be present in a total concentration of no more than 0.9 mg per mg of carbon aerogel. The at least one particle may be present in a total concentration of no more than 0.8 mg per mg of carbon aerogel. The at least one particle may be present in a total concentration of no more than 0.7 mg per mg of carbon aerogel. The at least one particle may be present in a total concentration of no more than 0.6 mg per mg of carbon aerogel. The at least one particle may be present in a total concentration of no more than 0.5 mg per mg of carbon aerogel. The at least one particle may be present in a total concentration of no more than 0.4 mg per mg of carbon aerogel. The at least one particle may be present in a total concentration of no more than 0.3 mg per mg of carbon aerogel. The at least one particle may be present in a total concentration of no more than 0.25 mg per mg of carbon aerogel. The at least one particle may be present in a total concentration of no more than 0.2 mg per mg of carbon aerogel. The at least one particle may be present in a total concentration of no more than 0.15 mg per mg of carbon aerogel. The at least one particle may be present in a total concentration of no more than 0.1 mg per mg of carbon aerogel. The at least one particle may be present in a total concentration of no more than 0.05 mg per mg of carbon aerogel. The at least one particle may be present in a total concentration of at least 0.001 mg per mg of carbon aerogel.

As disclosed herein, a precursor of the carbon aerogel may include a protein, such as an albumin. The protein may be self-assembling. The albumin may be derived from cattle blood, human blood, or chicken eggs.

The carbon fiber of the carbon aerogel may include interconnected dangling bonds of 3-, 4-, 5-, 6-, 7-, and/or 8-membered carbon rings, and/or spherical carbon rings, including any combination thereof. For example, in some embodiments, the carbon fiber may include interconnected dangling bonds of (i) 6-membered carbon rings and (ii) 5-membered carbon rings, 7-membered carbon rings, 8-membered carbon rings, or a combination thereof. In another embodiment, the carbon fiber may include interconnected dangling bonds of a spherical carbon ring and at least one 3-, 4-. 5-, 6-, 7-, or 8-membered carbon ring.

In some embodiments, one or more O-residual groups, N-residual groups, or both may be associated with the plurality of nano-sized pores, the plurality of structural defects, or both.

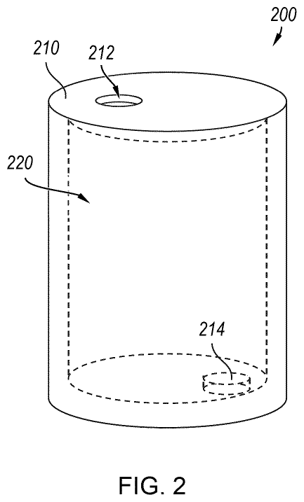

In various aspects, a filtration system may be provided. Referring to FIG. 2, a filtration system 200 may include a housing 210 having an input 212 and output 214. The filtration system may include a carbon aerogel 220 as disclosed herein within the housing, disposed in a fluid path between the input and output.

In various aspects, a method for separating materials, such as materials in a fluid mixture, or materials suspended or dispersed in a fluid. The method may include passing a fluid containing a liquid and at least one additional material through a carbon aerogel as disclosed herein. The liquid may be a polar liquid. The polar liquid may be water. The liquid may be a non-polar liquid. The non-polar liquid may a hydrocarbon-based resin or oil. The at least one additional material may include a salt or at least one microplastic.

The carbon aerogel may include one or more O-residual groups, N-residual groups, or both. Those residual groups may be associated with the nano-sized pores of the carbon aerogel, the structural defects of the carbon aerogel, or both.

In some embodiments, the method may include passing the fluid through a plurality of carbon aerogels as disclosed herein. In some embodiments, each carbon aerogel is identical. In some embodiments, at least one carbon aerogel may be different from at least one other carbon aerogel. For example, in one embodiment, the fluid is configured to pass through a first carbon aerogel with a first density, then through a second carbon aerogel with a second density, where the second density is different (e.g., greater than) the first density.

In some embodiments, the method may include recycling at least some of the fluid that has passed through a carbon aerogel, and passing it through that same carbon aerogel at least a second time.

The at least one additional material may be captured on a surface of the nano-sized pores and/or structural defects.

The method may include capturing at least some liquid after the fluid passes through the carbon aerogel. This may be collected in a container and may be collected in any appropriate manner. For example, in some embodiments, a sample may be collected via a tap in a line after the aerogel (e.g., if the filtration is occurring in a continuous process). In some embodiments, all liquid passing through the aerogel is collected in a container or vessel. In some embodiments.

The method may include quantifying a first amount of one or more of the at least one additional material remaining in the captured liquid. The method may include comparing the first amount to a previously quantified amount. This may be done using traditional analytical methods.

### Example 1

To prepare hierarchically interconnected 2D-graphitic carbon and 1D-carbon-fiber aerogel, egg white (EW) extracted from cage-free unpasteurized eggs was first freeze-dried and then pyrolyzed at 900° C. under N₂. Separately, in addition to the EW-proteins, pure ovalbumin from chicken eggs (OVA), bovine-serum-albumin derived from cows (BSA), and gelatin proteins derived from bovine skin (CG) were dissolved in DI-water (0.5 mg/ml) followed by freeze-drying and pyrolyzation at 900° C. under N₂.

The chemical composition of aerogels was measured by scanning electron microscopy (SEM) (FEI QUANTA™ 200 Field Emission Gun (FEG) Scanning Electron Microscope). While OVA and BSA consist of both α-helices and β-sheets with different structures, CG is made of α-helices with triple helices. In spite of the different molecular organization, the results after freeze-drying and pyrolysis treatments of BSA and OVA are similar to that of EW-proteins-micro-sized large graphitic carbon sheets seamlessly interconnected with carbon fiber via covalent bonding. Conversely, in the case of CG, the structure is dominated by micro-sized carbon fiber, while there are partial 2D-graphitic carbon sheets and a G-CF seamless network. The hierarchical G-CF aerogel obtained with EW is ultralightweight with a density of 0.0038±0.0006 g/cm³. Compared to the class of graphene nanoporous materials, the density is two orders of magnitude smaller.

To gain further insight into the morphology of G-CF aerogels made of EW-proteins, the surface and internal structure are imaged using scanning electron microscopy (SEM). A surface view of the hierarchically structured G-CF aerogel may see a rather flat surface, consisting of G-sheets, seamlessly interconnected with carbon fiber defining a micrometer-sized structure of adjacent pores. In order to understand the in-depth morphology of the G-CF aerogel, the block is sectioned, and the cross-section structure is imaged using SEM. The architecture of the G-CF aerogel entirely consists of porous cages made of G-sheets seamlessly stitched with CF. See, e.g., FIG. 1. Conversely, the inner structure of the CG derived structure obtained with the same treatment appear composed of elongated fibers and fibrils with micron-scale diameter and a small number of G-sheets. This difference stems from the supramolecular organization of the precursors, already in the pre-pyrolysis phase, due to CG having its own particular fiber organization.

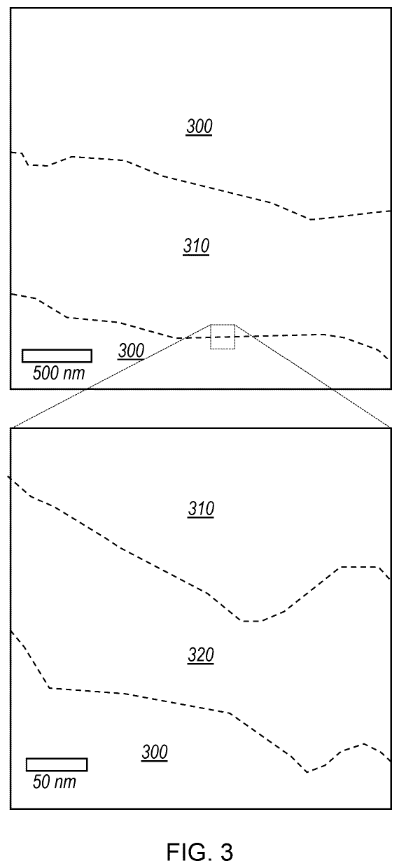

Detailed high-resolution transmission electron microscopy (HRTEM) was performed to elucidate the material nanostructure. Transmission electron microscopy was performed using a TALOS™ F200X Scanning/Transmission Electron Microscope (S/TEM). HRTEM with diffraction analysis shows that the G structure is polycrystalline. The G-structure contains hexagonal lattices with various defect structures such as single-point defects and vacancy defects. Intensity analysis of the TEM micrograph displays a periodicity of ˜2.5 Å, compatible with that of the theoretical value of the hexagonal lattice (2.6 Å). Referring to FIG. 3, the simplified version of a representative HRTEM is shown, with interconnected graphitic carbon 300 and carbon fiber 310. HRTEM of CF reveals that it consists of interconnected graphitic structures with high levels of defects. Additionally, an interface region 320 is observed where structural defects are present in large numbers. The average pore size distribution of the example G-CF aerogel network is around 4 nm, which is mostly coming from defects of carbon fiber and the interface connection between G and CF. In addition, double porous structure of the G-CF is an excellent pore structure of 3D architecture with a high packing density.

X-ray photoelectron spectroscopy (XPS) characterization is carried out using a K-Alpha+X-ray Photoelectron Spectrometer (XPS/UPS) from Thermo Fisher. The salt concentration in water was measured by inductively coupled plasma mass spectrometry (ICP-MS). Nitrogen adsorption-desorption isotherms and pore size distributions of the aerogels were measured at 77 K in powder form by Brunauer-Emmett-Teller (BET).

The formation of G-CF structures is confirmed by spectroscopic characterization. Raman spectra of carbon materials typically have two characteristic peaks, G-band and D-band, which are related to the sp² and sp³-carbon, respectively. In particular, the G-band confirms the presence of sp²-carbon, while the D bands indicate the presence of sp³-carbon as a result of defects in the hexagonal lattice of the graphitic carbon. The Raman spectra of the G-sheets and CF were measured separately. Raman spectroscopy analysis was collected using a Horiba Raman spectrometer with a 532 nm wavelength laser. A piece of the G-CF sample was placed on a microscope slide and mounted on the optical microscope stage. To measure the Raman spectra of 2D-graphitic carbon layer and carbon-fiber regions, these two structures were focused to separately with the optical microscope camera, and the Raman measurement was performed using 532 nm wavelength light.

Both structures display the two bands at 1348 cm⁻¹ and 1591 cm⁻¹, respectively. The relative defect density can be determined from the ratio between the D-band and G-band intensities, I_{D}:I_{G}. Here, it is found that the I_{D}:I_{D} ratio in the carbon fiber (I_{D}:I_{G}=1.01) is larger than in the G-sheet (I_{D}:I_{G}=0.89), confirming the HRTEM observation of a higher content of defects in the CF-structure.

X-ray diffraction (XRD) characterization was performed using a Bruker D8 DISCOVER™ X-ray Diffractometer. The X-ray diffraction (XRD) pattern of the pyrolyzed EW-proteins shows two peaks at 13.9 and 25.5 that correspond to oxygenated and N-doped graphitic carbon, respectively. In this example, the composition of the G-CF aerogel consists of 94.9% carbon, 4.08% oxygen, and 1.02% nitrogen atoms. In high-resolution XPS characterization, the C—C/C—O/C—N, C—O/C═N and π-π bond peaks are around 284.6 eV, 286.2 eV, 287.4 eV, and 289.2 eV, respectively. Fitting the NIs peak corresponds to pyridinic, pyrrolic, and N-doped graphitic structures at 398.2 eV, 399.6 eV, and 401.4 eV, respectively.

The pyrolysis of these two systems was simulated, and the formation of nano-sized pores was obtained, clearly visible in the final configuration of the G-sheet, and somewhat smaller in the fiber-structures. Pores form because of the large quantity of gases released during the process, which desorb from the surfaces of the sheets and fibers and fill the micro-bubbles, contributing to enlarging and stabilizing them, but at the same time creating voids at nanoscale. In agreement with the HRTEM observations, the superficial graphenized structure of the model sheet after pyrolysis is somewhat more ordered than that of the fiber, although not as ordered as the experimental one, which is in turn more similar to that obtained in the single sheet simulated pyrolysis. This slight discrepancy between simulation and experiment is essentially due to the supercell size and heating time, which could not be tuned to the experimental counterparts. Thus, in the simulations, only small ordered domains are observed.

### Example 2

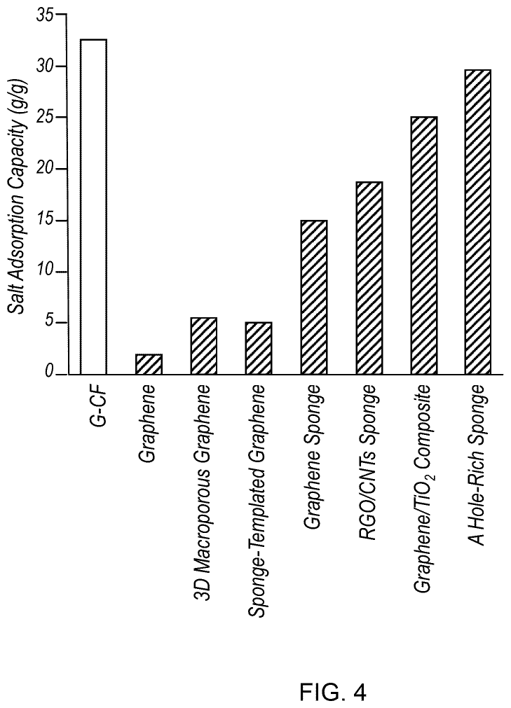

State-of-the-art water purification and desalination demands the development of green and inexpensive novel materials and technologies with specific porosity. There are various reports of processed natural materials for water desalination and purification via thermal and capacitive deionization (CDI), but they require energy input. Here, the disclosed carbon aerogels are used for water desalination and purification. The G-CF aerogel (5 mm thick-ness) is placed over the mouth of a funnel, and seawater (from the New Jersey shore) is allowed to pass through it at a 0.5 ml/min flow rate by gravity. The fast water adsorption, demonstrated by the decrease of the contact angle of the water droplet on the G-CF surface, is due to capillarity enhanced by the interaction of water with charged defects of the nanoporous matrix. Seawater is passed through the G-CF aerogel in 50 cycles, and the filtered seawater is analyzed by inductively coupled-plasma mass-spectrometry (ICP-MS). On the first cycle of seawater purification, 13.1% of Mg²⁺, 13.6% of K⁺, and 17.9% Ca²⁺ ions are rejected from the seawater. The ratio of salt ions decreases with increased purification cycles. At the end of 50 purification cycles, 92% Mg²⁺, 90.1% K⁺, and 94% Ca²⁺ ions are rejected. Conductivity and pH tests also show that the seawater is highly purified. The adsorption capacity of the G-CF aerogel is calculated by measuring the weight change before and after the water filtration (samples were dried overnight at 100° C.). The salt adsorption capacity of G-CF aerogels is ˜32.6 g/g. The salt adsorption capacity of G-CF aerogels is above the average reports in the literature. See FIG. 4.

In another demonstration, the disclosed carbon aerogel was shown to be effective for removing nano/micro plastics from water since nano/micro-plastic contamination in seawater is one of the major environmental issues. So far, studies mainly are focused on contamination by microplastics, and less attention is given to nanoplastics. The environmental impact of nanoplastics is expected to be different from microplastics because of their high surface area ratio that results strong adsorption with contaminants in seawater such as heavy metals. Here, ˜147 nm (2.72 mg/ml) and ˜400 nm (13.32 mg/ml) polystyrene (PS) microplastics contaminated water samples are prepared and purified by the same setup as the seawater desalination above. In the first cycle of purification, 93.2% (˜147 nm), and 98.5% (˜400 nm) of PS-nanoparticles, respectively, are removed from water using EW-Aerogels. After 15 cycles, the removal levels off to 99.986% of ˜147 nm and 99.995% of ˜400 nm size PS-nanoparticles, respectively, being removed from water. For comparison, the same experiment was repeated using activated-carbon (AC). In this case, after the first-cycle 82.4% of PS-nanoparticles (˜147 nm) are removed, and after the 15th-cycle the total removal asymptotes to 98.2%, which is similar to current state of the art materials. The improvement in microplastic removal with the carbon aerogel may be attributed to the specific adsorption mechanism in the disclosed material in which strong non-covalent interactions (e.g., π-π) exist between PS-nanoparticles and the carbon aerogel surface. Furthermore, the hierarchically organized multiscale porous structure of the carbon aerogel acts as an effective trap to adsorb nano/microplastic on the large surface, and thus the disclosed carbon aerogels are more effective than AC at removing microplastics. In addition, mass driving force is another effective mechanism for the diffusion of PS nano/micro plastics from the solution to the G-CF aerogels surface.

While the benefits of the aerogel for purification applications include its mechanical stability, low-cost, and durability, one key property enabling its efficacy is the double-level hierarchical porosity. The micron-level porosity allows water to quickly penetrate into the structure and selects possibly present macroscopic pollutant particles from seawater, while the nanoporosity acts as a salt filter. The desalinization is hypothesized to be made more efficient by the O- and N-residual functional groups residing on the nano-sized pores and defects (see FIG. 4), acting as traps for the ions. This effect is likely to be enhanced by a system of nano-channels present in the G-sheets-CF-matrix, which additionally improves the separation of the ions and larger particles due to the double-level porosity, while the aerogel structure favors the water adsorption ensuring at the same time large structural stability against swelling. The final result is purified and desalinized water. The SEM images of G-CF aerogel after seawater pass through show that a layer of salt and other impurities is deposited on the surface of the aerogel.

In order to gain insight into the ion-filtering mechanism at the molecular-level, MD-simulations were performed of a nanoporous fiber taken from previous simulations, periodically repeated to mimic the structure of nano-channels forming within the nano-fiber-matrix, and completely hydrated and with Na⁺, Mg²⁺ and Cl⁻-ions concentrations as in seawater. Water penetrates through the interstitials of the porous carbon structure, as expected; interestingly, however, it also fills the nano-sized pores easily within the fiber itself. While water mobility is high, ions are clearly trapped on the surface or within cavities of the carbon-fiber. Ions show a preferential accumulation near the sites occupied by N or O functionalities. This preference is confirmed by the radial distribution functions (RDF): while the RDF of the ions with C is relatively flat, the RDF of ions with N and with O display well-marked coordination peaks, indicating that their complexes with the N and O functional sites on the fiber are stable.

To clarify the molecular interaction mechanism, it was first observed that the ions, which usually have full water coordination shells when in solution, are only partially hydrated when trapped on the fiber. There are important differences between the RDFs of different ions due to the different behavior of their coordination shells: sodium has two peaks at very short distances because the carbonyl O in the fiber is capable of replacing one of the oxygen of its hydration shell. This is not possible with magnesium and especially with chlorine, whose direct coordination is with H of water. Conversely, Cl can be coordinated to the hydrogen of NH groups, occasionally protonated in the fiber, which explains its ability to reach the shorter distance to N. The trapping mechanism is an effect of the mediation of water molecules between the ion and the C and N sites in the fiber, rather than an electrostatic effect.

The mechanical properties of water desalination and purification materials is critical not only for their design, also for understanding their failure mechanisms, including the surface damage, mechanical and chemical aging, delamination, and loss of dimensional stability of the structures. In addition to good chemical and fouling resistances, materials for water desalination and purification require high mechanical stability and durability. The compression loading curve of G-CF structure made out of the fresh egg white indicates that the aerogel can be compressed down to about 90% strain. As the load of the aerogel increases, the nature of the curve remains the same during the loading-unloading test. The compression stress of the G-CF aerogel is ˜3.1 Mpa, which can indicate that the graphitic carbon and carbon-fiber in the G-CF aerogel is seamlessly interconnected.

### Example 3 (Aerogels with Different Carbon Content)

Various aerogels were created using the processing parameters in Table 1, showing the effect of different processing conditions on the carbon content of the aerogel.

TABLE 1
Processing Conditions for the disclosed method,
and properties of the resulting aerogel.

| | ID# | | |
|---|---|---|---|
| | 1 | 2 | 3 |
| Precursors | Egg white | Egg white | Egg white |
| First Temperature (° C.) | 600 | 800 | 900 |
| First Heating Rate (° C./min) | 38 | 38 | 38 |
| Carbon Content (wt %) | 66 | 71 | 88 |

As is known in the art, egg white comprises multiple organic molecules, including various proteins such as ovalbumin (˜54%), ovotransferrin (˜12%), ovomucoid (˜11%), ovoglobulin G2 (˜4%), ovoglobulin G3 (˜4%), ovomucin (˜3.5%), Lysozyme (˜3.4%), Ovoinhibitor (˜1.5%), ovoglycoprotein (˜1%), Flavoprotein (˜0.8%), Ovomacroglobulin (˜0.5%), Avidin (˜0.05%), and Cystatin (˜0.05%).

### Example 4 (Adding Particles to Aerogel)

Various aerogels were created using the processing parameters in Table 2.

TABLE 2
Processing Conditions for the disclosed method.

| | ID# | | |
|---|---|---|---|
| | 4 | 5 | 6 |
| Precursors | Egg white | Egg white | Egg White |
| First Temperature (° C.) | 900 | 900 | 900 |
| First Heating Rate (° C./min) | 38 | 38 | 38 |
| Particle addition (mg of particle | 0 | 0.1 | 0.5 |
| per ml of egg white) | | | |

### Example 5 (Varying Density of Aerogel)

Various aerogels were created using the processing parameters in Table 3, showing the effect of different processing conditions on the density of the aerogel.

TABLE 3
Processing Conditions for the disclosed method,
and properties of the resulting aerogel.

| | ID# | | | | |
|---|---|---|---|---|---|
| | 7 | 8 | 9 | 10 | 11 |
| Precursors | Egg White | Egg White | Egg White | Egg White | Egg White |
| First | 900 | 900 | 900 | 900 | 900 |
| Temperature | | | | | |
| (° C.) | | | | | |
| First Heating | 38 | 7.5 | 5 | 2.5 | 1.25 |
| Rate | | | | | |
| (° C./min) | | | | | |
| Density | 0.0038 | 0.0116 | 0.0146 | 0.0155 | 0.0223 |
| (g/cm³) | | | | | |

### Example 6 (Using Different Precursors)

Various aerogels were created using the processing parameters in Table 4, showing the effect of different precursors on the resulting aerogel network.

TABLE 4
Processing Conditions for the disclosed method,
and properties of the resulting aerogel.

ID#

| | 12 | 13 | 14 |
|---|---|---|---|
| Precursors | Egg White | Whey Protein | Sugar |
| First Temperature (° C.) | 900 | 900 | 900 |
| First Heating Rate | 38 | 38 | 38 |
| (° C./min) | | | |
| Sheet and fiber network | Yes | Yes | Yes |
| formation | | | |

The sugar used was organic cane sugar, composed of sucrose. Similar results were generated with turbinado sugar (96-99% sucrose) and molasses.

### Example 7 (Varying Fiber Width of Aerogel)

Various aerogels were created using the processing parameters in Table 5, showing the effect of processing conditions on average fiber width.

TABLE 5
Processing Conditions for the disclosed method,
and properties of the resulting aerogel.

| | ID# | | | |
|---|---|---|---|---|
| | 16 | 17 | 18 | 19 |
| Precursors | Egg white | Egg white | Egg white | Egg white |
| First Temperature | 900 | 900 | 900 | 900 |
| (° C.) | | | | |
| First Heating Rate | 38 | 7.5 | 5 | 1.25 |
| (° C./min) | | | | |
| Avg. fiber width | 12 | 20 | 27 | 45 |
| (μm) | | | | |

### Example 8 (Varying First Temperature to Check if Aerogel Forms)

Various aerogels were created using the processing parameters in Table 6, showing the effect of different first temperatures on the resulting aerogel network.

TABLE 6
Processing Conditions for the disclosed method,
and properties of the resulting aerogel.

| ID# | 20 | 21 | 22 | 23 | 24 | 25 |
|---|---|---|---|---|---|---|
| Precursors | Egg | Egg | Egg | Egg | Egg | Egg |
| | White | White | White | White | White | White |
| First Temper- | 200 | 400 | 600 | 800 | 1000 | 1100 |
| ature (° C.) | | | | | | |
| First Heating | 38 | 38 | 38 | 38 | 38 | 38 |
| Rate (° C./min) | | | | | | |
| Formation of | No | Yes | Yes | Yes | Yes | Yes |
| Sheet and | | | | | | |
| Fiber Carbon | | | | | | |
| Aerogel | | | | | | |

### Example 9 (Carbon Aerogels with Different Surface Area)

Various aerogels were created using the processing parameters in Table 7, showing the effect of different heating rates on the resulting aerogel network.

TABLE 7
Processing Conditions for the disclosed method,
and properties of the resulting aerogel.

ID#

| | 26 | 27 |
|---|---|---|
| Precursors | Egg white | Egg White |
| First Temperature (° C.) | 900 | 900 |
| First Heating Rate (° C./min) | 38 | 7.5 |
| Surface Area (m²/g) | 732 | 47.2 |

### Example 10 (Presence of N, P, K, O, S, Mg, Cl, and/or Na in Aerogel)

Various aerogels were created using the processing parameters in Table 8, showing the effect of different first temperatures on the resulting aerogel network.

TABLE 8
Processing Conditions for the disclosed method,
and properties of the resulting aerogel.

| | ID# | | | | |
|---|---|---|---|---|---|
| | 28 | 29 | 30 | 31 | 32 |
| Precursors | Egg | Egg | Egg | Egg | Egg |
| | White | White | White | White | White |
| First Temperature (° C.) | 400 | 600 | 800 | 1000 | 1100 |
| First Heating Rate | 38 | 38 | 38 | 38 | 38 |
| (° C./min) | | | | | |
| Presence of N, P, K, O, | Yes | Yes | Yes | Yes | Yes |
| S, Mg, Cl, and/or Na | | | | | |

Generally speaking, the percentage of impurities decreases as the first temperature increased, although the aerogel was never pure carbon when starting from egg white.

Various modifications may be made to the systems, methods, apparatus, mechanisms, techniques and portions thereof described herein with respect to the various figures, such modifications being contemplated as being within the scope of the invention. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof. As such, the appropriate scope of the invention is to be determined according to the claims.

1. A method for manufacturing a carbon aerogel, comprising:
drying a precursor composition including an organic molecule; and
generating a porous aerogel by graphitizing the organic molecule, the graphitizing including:
heating the precursor composition to a first temperature of 300-1200° C. at a first heating rate; and
holding the precursor composition at the first temperature for a holding time no more than 48 hours;
wherein generating the porous aerogel is accomplished without a separate gas generant.

2. The method of claim 1, wherein the precursor composition is heated to the first temperature in an atmosphere consisting of nitrogen, argon, or a combination thereof.

3. The method of claim 1, wherein the organic molecule comprises a protein-based precursor and/or a sugar-based precursor.

4. The method of claim 3, wherein the protein-based precursor is ovalbumin, whey protein, Bovine serum albumin, collagen gelatin, or a combination thereof.

5. The method of claim 1, wherein the first temperature is 300-1000° C.

6. The method of claim 1, wherein the heating rate is at least 100° C./min.

7. The method of claim 1, wherein the heating rate is no more than 100° C./min.

8. The method of claim 7, wherein the heating rate is no more than 40° C./min.

9. The method of claim 8, wherein the heating rate is 1-10° C./min.

10. The method of claim 9, wherein the heating rate is 3-10° C./min.

11. The method of claim 1, wherein the precursor composition consists of the organic molecule.

12. The method of claim 1, wherein the precursor composition consists of the organic molecule and one or more particles.

13. The method of claim 12, wherein the particles are present in a total concentration of no more than 20 mg/mL of the organic molecule.

14. The method of claim 12, wherein the particles comprise a metal or a metalloid.

15. The method of claim 12, wherein the particles comprise a non-metal.

16. The method of claim 1, wherein the precursor composition consists of the organic molecule and one or more metal particle precursors.

17. A carbon aerogel formed by the method of claim 1.

18. A carbon aerogel, comprising: micro-sized large graphitic carbon sheets interconnected with carbon fibers via covalent bonding; wherein the carbon aerogel comprises a plurality of micro-sized pores, and a plurality of nano-sized pores: wherein the carbon aerogel has a density of no more than 0.1 g/cm³; wherein the carbon fibers have an average fiber width of 46 μm or less; wherein the carbon aerogel has a carbon content of at least 60%; and wherein the graphitic carbon sheets contain a plurality of structural defects.

19-31. (canceled)

32. A filtration system comprising:
a housing having an input and output; and
a carbon aerogel of claim 18 within the housing, disposed in a fluid path between the input and output.

33. A method for separation of materials, comprising:
passing a fluid containing a liquid and al least one additional material through a carbon aerogel of claim 18;
wherein the carbon aerogel comprises one or more O-residual groups, N-residual groups, or both, associated with the plurality of nano-sized pores of the carbon aerogel, the plurality of structural defects of the carbon aerogel, or both.

34-40. (canceled)
